(19) United States
(12) Patent Application Publication
(10) Pub. No.: US 2026/0279023 A1
(43) Pub. Date: Sep. 17, 2026

(54) TARGET DETECTION MODEL CONSTRUCTION METHOD AND APPARATUS, TARGET DETECTION METHOD AND APPARATUS, AND DEVICE, MEDIUM AND PRODUCT

(71) Applicant: Beijing Zitiao Network Technology Co., Ltd., Beijing (CN)

(72) Inventors: Mingxu DING, Beijing (CN); Dengke DONG, Beijing (CN)

(21) Appl. No.: 19/168,765

(22) PCT Filed: Mar. 14, 2024
(86) PCT No.: PCT/CN2024/081690

§ 371 Date: Sep. 24, 2025

(30) Foreign Application Priority Data
Mar. 31, 2023 (CN) 202310343525.4

(51) Int. Cl. G06V 10/776; G06V 10/25; G06V 10/74; G06V 10/764; G06V 10/98

(52) U.S. Cl. CPC G06V 10/776; G06V 10/25; G06V 10/761; G06V 10/764; G06V 10/98; G06V 2201/07

(57) ABSTRACT

Provided in the embodiments of the present disclosure are a target detection model construction method and apparatus, a target detection method and apparatus, and a device, a medium and a product. The target detection model construction method comprises: on the basis of a target detection model, determining a plurality of anchor boxes and a labeling box of a sample image; on the basis of at least one labeling box of the sample image, selecting, from among the plurality of anchor boxes, a target anchor box that meets an anchor box similarity condition; determining an anchor box classification threshold value on the basis of the at least one labeling box and the target anchor box; performing iterative updating on the target detection model according to the anchor box classification threshold value and the plurality of anchor boxes corresponding to the sample image; and in response to the iteration of the target detection model not being terminated, determining the proportion of a first-quality anchor box among the plurality of anchor boxes according to a quality evaluation threshold value, and in response to the proportion of the first-quality anchor box being greater than a preset proportion threshold value, updating the target anchor box, wherein the quality evaluation threshold value is determined on the basis of the anchor box classification threshold value, and the first-quality anchor box is an anchor box, among the plurality of anchor boxes, which has an intersection over union with the at least one labeling box greater than the quality evaluation threshold value.

### CROSS-REFERENCE TO RELATED APPLICATIONS

This application is a U.S. national stage application of International Patent Application No. PCT/CN2024/081690, filed on Mar. 14, 2024, which is based on and claims the benefits of priority to the Chinese patent application No. 202310343525.4, filed on Mar. 31, 2023, the entire contents of which are hereby incorporated by reference in their entireties into the present application.

### TECHNICAL FIELD

Embodiments of the present disclosure relate to the field of computer technology and, in particular, to a target detection model construction method and apparatus, a target detection method and apparatus, a device, a medium, and a product.

### BACKGROUND

A target detection model generally detects a target object in an image by using an algorithm such as a deep neural network and obtains an object class of the target object, such as detecting a vehicle, a streetlight, pedestrian, etc. in the image. The target detection model can typically detect multiple objects in the image, and a region of each object can be marked with a detection box.

### SUMMARY

According to a first aspect, an embodiment of the present disclosure provides a target detection model construction method, comprising:
determining a plurality of anchor boxes of a sample image based on a target detection model;
selecting, from the plurality of anchor boxes, target anchor boxes that meet an anchor box similarity condition based on at least one ground truth box of the sample image;
determining an anchor box classification threshold based on the at least one ground truth box and the target anchor boxes;
performing iterative update to the target detection model based on the anchor box classification threshold and the plurality of anchor boxes corresponding to the sample image; and
determining, in response to an iteration of the target detection model not being terminated, a proportion of first-quality anchor boxes among the plurality of anchor boxes according to a quality evaluation threshold, and updating the target anchor boxes in response to the proportion of the first-quality anchor boxes being greater than a preset proportion threshold, the quality evaluation threshold being determined based on the anchor box classification threshold, the first-quality anchor boxes being anchor boxes, among the plurality of anchor boxes, that have an Intersection over Union (IOU) with the ground truth box greater than the quality evaluation threshold.

According to a second aspect, an embodiment of the present disclosure provides a target detection method, comprising:
determining an image to be detected in response to a target detection request; and
outputting a detection result of a target object in the image to be detected based on a target detection model, the target detection model being constructed based on the target detection model construction method provided in the first aspect above.

According to a third aspect, an embodiment of the present disclosure provides a target detection model construction apparatus, comprising:
a determination unit, configured to determine a plurality of anchor boxes of a sample image based on a target detection model;
a selection unit, configured to select, from the plurality of anchor boxes, target anchor boxes that meet an anchor box similarity condition based on at least one ground truth box of the sample image;
a threshold unit, configured to determine an anchor box classification threshold based on the at least one ground truth box and the target anchor boxes;
an iteration unit, configured to perform iterative update to the target detection model according to the anchor box classification threshold and the plurality of anchor boxes corresponding to the sample image; and
an update unit, configured to determine, in response to an iteration of the target detection model not being terminated, a proportion of first-quality anchor boxes among the plurality of anchor boxes according to a quality evaluation threshold, and update the target anchor boxes in response to the proportion of the first-quality anchor boxes being greater than a preset proportion threshold, the quality evaluation threshold being determined based on the anchor box classification threshold, the first-quality anchor boxes being anchor boxes, among the plurality of anchor boxes, that have an Intersection over Union (IOU) with the ground truth box greater than the quality evaluation threshold.

According to a fourth aspect, an embodiment of the present disclosure provides a target detection apparatus, comprising:
a response unit, configured to determine an image to be detected in response to a target detection request; and
an input unit, configured to output a detection result of a target object in the image to be detected based on a target detection model, the target detection model being trained based on the target detection model construction method provided in the first aspect above.

According to a fifth aspect, an embodiment of the present disclosure provides an electronic device, comprising: a processor and a memory, the memory storing computer-executable instructions, the processor executing the computer-executable instructions stored in the memory such that at least one processor executes the target detection model construction method according to the first aspect as well as various possible target detection model construction methods that may be involved in the first aspect or the target detection method according to the second aspect as well as various possible target detection methods that may be involved in the second aspect.

According to a sixth aspect, an embodiment of the present disclosure provides a computer-readable storage medium having stored thereon computer-executable instructions that, when executed by a processor, implement the target detection model construction method according to the first aspect as well as various possible target detection model construction methods that may be involved in the first aspect or the target detection method according to the second aspect as well as various possible target detection methods that may be involved in the second aspect.

According to a seventh aspect, an embodiment of the present disclosure provides a computer program product comprising a computer program that, when executed by a processor, implements the target detection model construction method according to the first aspect as well as various possible target detection model construction methods that may be involved in the first aspect or the target detection method according to the second aspect as well as various possible target detection methods that may be involved in the second aspect.

According to an eighth aspect, an embodiment of the present disclosure provides a computer program comprising instructions that, when executed by a processor, cause the processor to perform the target detection model construction method according to the first aspect as well as various possible target detection model construction methods that may be involved in the first aspect or the target detection method according to the second aspect as well as various possible target detection methods that may be involved in the second aspect.

### BRIEF DESCRIPTION OF DRAWINGS

In order to more clearly illustrate the embodiments of the present disclosure or the technical solutions in the prior art, brief introduction will be given below for the drawings required to be used in the description of the embodiments or the prior art. It is apparent that the drawings described below are some embodiments of the present disclosure, and for those skilled in the art, they may also obtain other drawings according to these drawings, without spending any inventive effort.

FIG. 1 is a diagram of an application network architecture of a target detection model construction method provided in an embodiment of the present disclosure.

FIG. 2 is a flowchart of a target detection model construction method provided in an embodiment of the present disclosure.

FIG. 3 is a diagram of example anchor boxes provided in an embodiment of the present disclosure.

FIG. 4 is a flowchart of a target detection model construction method provided in an embodiment of the present disclosure.

FIG. 5 is a flowchart of a target detection model construction method provided in an embodiment of the present disclosure.

FIG. 6 is a flowchart of a target detection model construction method provided in an embodiment of the present disclosure.

FIG. 7 is a flowchart of a target detection method provided in an embodiment of the present disclosure.

FIG. 8 is a diagram of an example structure of a target detection model construction apparatus provided in an embodiment of the present disclosure.

FIG. 9 is a diagram of an example structure of a target detection apparatus provided in an embodiment of the present disclosure.

FIG. 10 is a schematic diagram of a hardware structure of an electronic device provided in an embodiment of the present disclosure.

### DETAILED DESCRIPTION

To make the objectives, technical solutions and advantages of the embodiments of the present disclosure clearer, the technical solutions in the embodiments of the present disclosure will be clearly and completely described below with reference to the drawings in the embodiments of the present disclosure. It is obvious that the embodiments described are some, but not all embodiments of the present disclosure. All other embodiments, which can be obtained by those skilled in the art based on the embodiments in the present disclosure without spending any inventive effort, shall fall within the protection scope of the present disclosure.

In the related art, the computing power of terminal devices is poor. Terminal devices may be, for example, mobile phones, vehicle-mounted devices, tablet computers, handheld devices, etc. Terminal devices can be configured with a target detection model obtained by training, and can use the target detection model to detect targets such as vehicles, faces, streetlights, and/or license plates. In the related art, the target detection model can generally set a plurality of anchor boxes in the image and use a fixed set threshold to classify the anchor boxes to obtain positive and negative samples. Detection boxes are predicted by using the anchor boxes that are classified as positive samples. In order to realize the target detection by terminal devices, an anchor box matching training strategy can be typically adopted. The strategy can set a plurality of anchor boxes and a corresponding ground truth box (GT), and calculate an Intersection over Union (IOU) value between each of the plurality of anchor boxes and the ground truth box, to obtain the IOU value corresponding to each of the plurality of anchor boxes. The IOU value of each anchor box is utilized to determine whether each anchor box belongs to a positive sample or belongs to a negative sample. However, when using an IOU threshold that is directly set, false negatives and false positives are prone to occur. If the IOU threshold is too high, it may lead to false negatives, and if the IOU threshold is too low, it may lead to multiple false positives.

As previously described, the accuracy of a detection box obtained by detection by utilizing a fixed threshold is not high.

For the above technical problem, the embodiments of the present disclosure provide a target detection model construction method and apparatus, a target detection method and apparatus, a device, a medium, and a product, to overcome the defect of inaccurate target detection caused by low training accuracy of the target detection model.

The technical solutions of the present disclosure can be applied to intelligent transportation, target tracking, and video special effect application and the like in the fields of artificial intelligence, computer vision, etc. In the process of iterative training of a target detection model, a cascaded strategy for anchor box matching can be implemented based on a dynamic threshold. The cascaded strategy can refer to using the quality evaluation of anchor boxes to update target anchor boxes after the end of one iterative update, using the target anchor boxes to realize a dynamic adjustment of the threshold, and realizing an adaptive adjustment using an anchor box quality evaluation threshold and an anchor box classification threshold, which can improve the detection effect of the anchor box classification threshold on the target detection model, obtain more accurate classification results of positive and negative samples, reduce false positives, and improve the recall rate of the target detection model.

In the embodiments of the present disclosure, in the process of constructing the target detection model, based on a plurality of anchor boxes and a ground truth box for a sample image, target anchor boxes can be selected from the plurality of anchor boxes using the ground truth box. The target anchor boxes are anchor boxes that meet an anchor box similarity condition, such that the target anchor boxes and the ground truth box meet the similarity condition. By setting the anchor box similarity condition, the filtering of target anchor boxes can be realized. After the target anchor boxes are obtained, an anchor box classification threshold can be determined by using the ground truth box and the target anchor boxes. Since the target anchor boxes are closer to the ground truth box, by involving the target anchor boxes in the anchor box classification threshold determination process, a more reasonable anchor box classification threshold can be determined. According to the anchor box classification threshold and the plurality of anchor boxes corresponding to the sample image, iterative update to the target detection model can be performed. When an iteration of the target detection model is not terminated, a proportion of first-quality anchor boxes among the plurality of anchor boxes can be determined according to a quality evaluation threshold. If the proportion of the first-quality anchor boxes is greater than a preset proportion threshold, the target anchor box can be updated. The quality evaluation threshold is determined based on the anchor box classification threshold. When the proportion of the first-quality anchor boxes is greater than the preset proportion threshold, the target anchor box can be updated to realize an adjustment of the anchor box classification threshold. The adjusted anchor box classification threshold can enable the target detection model to classify the anchor boxes more accurately, thereby improving the detection accuracy of the target classification model and reducing the false positive rate.

The technical solution of the present disclosure and how the technical solution of the present disclosure solves the above technical problem will be described in detail below by way of embodiments. The following several embodiments may be combined with each other, and the same or similar concepts or processes may not be repeated in some embodiments. The embodiments of the present invention will be described in detail below with reference to the accompanying drawings.

FIG. 1 is a diagram of an application network architecture of a target detection model construction method provided in the present disclosure. The application network architecture according to the embodiment of the present disclosure may include one electronic device and one client that is connected with the electronic device via a local area network or a wide area network. It is assumed that the electronic device may be a personal computer, a regular server, a super personal computer, and a type of server such as a cloud server. The present disclosure does not make too many restrictions to the specific type of the electronic device. The client may, for example, be a terminal device such as a mobile phone, a tablet computer, a vehicle-mounted device, a smart home appliance, a wearable device. The present disclosure does not make too many restrictions to the specific type of the client. As shown in FIG. 1, the technical solution of the present disclosure is described in detail by using an example in which the electronic device is a cloud server 11 and the client is a vehicle-mounted terminal 12.

For example, the cloud server 11 may obtain a target detection model by training the target detection model through the target detection model construction method of the present disclosure. The target detection model may be sent to the vehicle-mounted terminal 12, which is only exemplary, and in turn, during the operation of the vehicle-mounted terminal 12, detect a target in an image 13 to be detected, e.g., a vehicle 131, a pedestrian 132, etc., to realize accurate detection of the detected target.

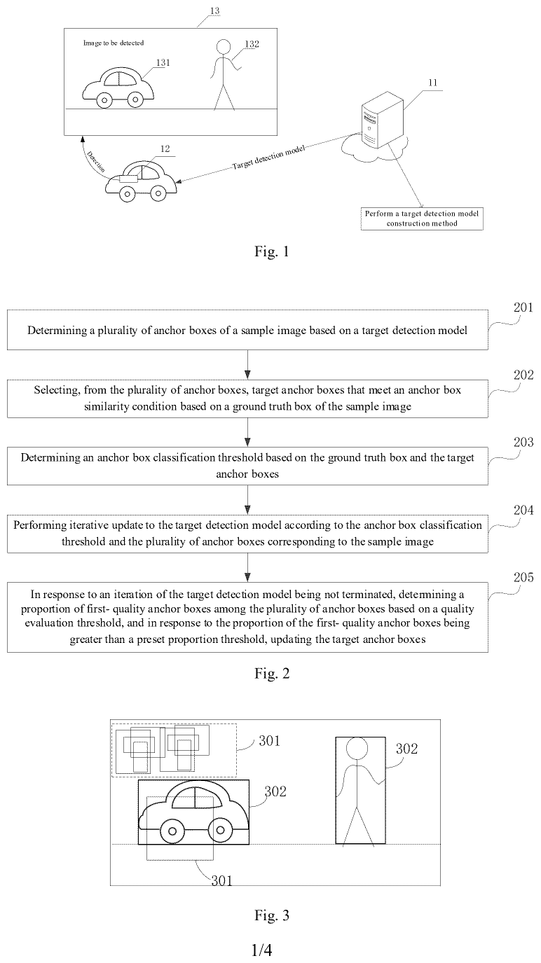

Referring to FIG. 2, a flowchart of a target detection model construction method provided in an embodiment of the present disclosure is shown. The method may comprise the following steps:
201: determining a plurality of anchor boxes of a sample image based on a target detection model.

For example, the anchor boxes can be fixed reference boxes of different sizes and aspect ratios set in the image. When constructing the target detection model, a training sample can be constructed by the degree of intersection between a ground truth box and an anchor box, that is, the plurality of anchor boxes can be classified as positive samples and negative samples through the target detection model. Detection targets are further determined by using the classified positive samples. In practical applications, for an image, the number of anchor boxes can be set to a 4-digit or even 5-digit number. Thus, the sample classification for anchor boxes is relatively important. Of course, in order to ensure adequate detection of each coordinate point in the image, multi-scale anchor box settings can be performed for the same pixel, that is, a plurality of anchor boxes centered on the pixel are set. The pixel can be obtained by pixel sampling from the sample image. In addition, it is also possible to perform anchor box setting separately for at least one channel image corresponding to the sample image, achieving the anchor box setting with smaller image processing units to improve anchor box setting accuracy.
202: selecting, from the plurality of anchor boxes, target anchor boxes that meet an anchor box similarity condition based on a ground truth box of the sample image.

The sample image may also be associated with at least ground truth box. Ground truth boxes may be used to mark rectangular boxes and class labels of detection targets or objects. For example, the ground truth boxes may include a rectangular box corresponding to a vehicle and a vehicle class label, respective rectangular boxes of one or more pedestrians in the image and pedestrian class labels, and a rectangular box corresponding to a road and a road label, etc. Thus, one sample image may be associated with at least one ground truth box, each ground truth box is associated with a class label, and the class label may be a label of a detection target in the ground truth box. IOU calculation is performed on an anchor box and at least one ground truth box to obtain the largest IOU value corresponding to the anchor box. When the largest IOU value is greater than an IOU threshold, the anchor box is determined as a positive sample, and the class label of the ground truth box corresponding to the largest IOU value can be used as the class label of the anchor box. For example, if the label class of the ground truth box corresponding to the anchor box is the “cat”, then the “cat” can be used as the class of a detection target in the anchor box, i.e., it can be determined that the detection target in the anchor box is a cat.

For ease of understanding, FIG. 3 shows a diagram of example anchor boxes. One sample image 300 may include a plurality of anchor boxes 301, and the sizes and positions of the anchor boxes may be different. Of course, the number, sizes and positions of the anchor boxes are all exemplary and should not constitute specific limitations. In practical applications, anchor boxes can be spread over the entire sample image, which is not shown here for the sake of clarity of the example. Referring to ground truth box 302 in FIG. 3, the ground truth box may be a pre-labeled true rectangular box that can accurately surrounds a detection target. The ground truth box can be associated with a target class of the detection target within the box.

For example, the anchor box similarity condition may be indicated by the degree of similarity between the anchor box and the ground truth box. For example, according to the degree of similarity between each of the plurality of anchor boxes and the ground truth box, top-K anchor boxes with a higher degree of similarity can be selected as target anchor boxes. A similarity threshold can also be set, and according to the degree of similarity between each of the plurality of anchor boxes and the ground truth box, anchor boxes with a degree of similarity greater than the similarity threshold can be selected as target anchor boxes.
203: determining an anchor box classification threshold based on the ground truth box and the target anchor boxes.

The anchor box classification threshold can be a value for determining anchor boxes as positive or negative samples in the process of constructing the target detection model. When the IOU value corresponding to an anchor box is greater than the anchor box classification threshold, the anchor box is a positive sample, and when the IOU value corresponding to an anchor box is less than the anchor box classification threshold, the anchor box is a negative sample.

For example, step 203 may include: calculating IOU values of the ground truth box and the target anchor boxes corresponding to the ground truth box, and calculating the anchor box classification threshold based on the IOU values corresponding to the respective target anchor boxes.

For example, at least one ground truth box can be included. Step 203 may be: determining an anchor box classification threshold based on the at least one ground truth box and the target anchor boxes corresponding to each of the at least one ground truth box. For the manner of calculating the anchor box classification threshold, reference can be made to the detailed description of the following embodiments.
204: performing iterative update to the target detection model according to the anchor box classification threshold and the plurality of anchor boxes corresponding to the sample image.

For example, performing iterative update to the target detection model may refer to continuously performing iterative update to model parameters of the target detection model. At the time of performing iterative update to the target detection model, the anchor box classification threshold can be updated synchronously. The anchor box classification threshold can be involved in the iterative updating process of the target detection model, and the model parameters of the target detection model can be continuously optimized through the adjustment of the anchor box classification threshold.

For example, the target detection model can predict an offset between the anchor box and ground truth box to obtain a predicted result of the offset between the anchor box and its ground truth box, and perform error calculation based on the predicted result and a true value offset between the anchor box and its corresponding ground truth box to obtain error loss, and the target detection model is updated by using the error loss.
205: if an iteration of the target detection model is not terminated, determining a proportion of first-quality anchor boxes among the plurality of anchor boxes based on a quality evaluation threshold, and if the proportion of the first-quality anchor boxes being greater than a preset proportion threshold, updating the target anchor boxes, the quality evaluation threshold being determined based on the anchor box classification threshold, the first-quality anchor boxes being anchor boxes, among the plurality of anchor boxes, that have an Intersection over Union (IOU) with the ground truth box greater than the quality evaluation threshold.

For example, if the iteration of the target detection model is terminated, the target detection model when the iteration is terminated is obtained. The target detection model obtained when the iteration is terminated can be used to detect and obtain a detection box where a target object is located in the image to be detected, and output a class corresponding to the detection box. The class corresponding to the detection box is an object class to which the target object belongs.

For example, the iteration of the target detection model not being terminated may include: the error loss of the target detection model being greater than a loss threshold and/or a predetermined number of iterations not being reached.

In the embodiments of the present disclosure, in the process of constructing the target detection model, based on a plurality of anchor boxes and a ground truth box for a sample image, target anchor boxes can be selected from the plurality of anchor boxes. The target anchor boxes are anchor boxes that meet an anchor box similarity condition, such that the target anchor boxes and the ground truth box meet the similarity condition. By setting the anchor box similarity condition, the filtering of target anchor boxes can be realized. After the target anchor boxes are obtained, an anchor box classification threshold can be determined by using the ground truth box and the target anchor boxes Since the target anchor boxes are closer to the ground truth box, by involving the target anchor boxes in the anchor box classification threshold determination process, a more reasonable anchor box classification threshold can be determined. According to the anchor box classification threshold and the plurality of anchor boxes corresponding to the sample image, iterative update to the target detection model can be performed. When an iteration of the target detection model is not terminated, aproportion of first-quality anchor boxes among the plurality of anchor boxes can be determined according to a quality evaluation threshold. If the proportion of the first-quality anchor boxes is greater than a preset proportion threshold, the target anchor boxes can be updated. The quality evaluation threshold is determined based on the anchor box classification threshold. When the proportion of the first-quality anchor boxes is greater than the preset proportion threshold, the target anchor boxes can be updated to realize an adjustment of the anchor box classification threshold. The adjusted anchor box classification threshold can enable the target detection model to perform more accurate classification of anchor boxes, thereby improving the detection accuracy of the target classification model and reducing the false positive rate.

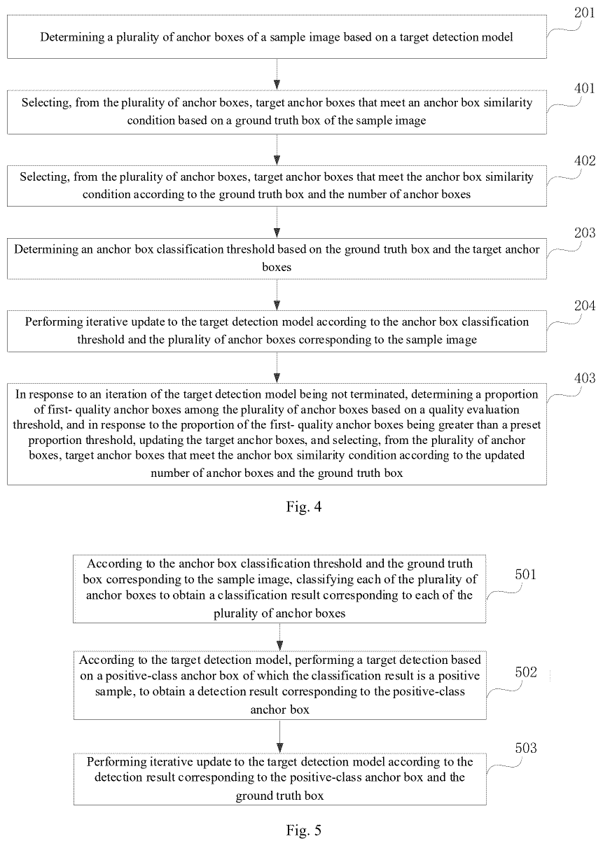

FIG. 4 shows a flowchart of a target detection model construction method provided in an embodiment of the present disclosure, which differs from the foregoing embodiment in that step 202 of selecting, from the plurality of anchor boxes, target anchor boxes that meet an anchor box similarity condition based on a ground truth box may comprise the following steps:
401: determining a number of anchor boxes corresponding to the target anchor boxes set for the ground truth box.

For example, in the present embodiment, the number of anchor boxes corresponding to the target anchor boxes can be represented by a symbol k. One ground truth box can correspond to k target anchor boxes.
402: selecting, from the plurality of anchor boxes, target anchor boxes that meet the anchor box similarity condition according to the ground truth box and the number of anchor boxes.

In step 205, updating the target anchor boxes may include:
403: updating the number of anchor boxes, and selecting, from the plurality of anchor boxes, target anchor boxes that meet the anchor box similarity condition according to the updated number of anchor boxes and the ground truth box.

In the embodiment of the present disclosure, in the iterative updating process of the target detection model, the number of anchor boxes of the target anchor boxes can be set, and the process of selecting the target anchor boxes are constrained according to the number of anchor boxes of the target anchor boxes, such that the selection of the target anchor boxes is adapted to the number of anchor boxes.

For example, on the basis of any of the above embodiments, updating the number of anchor boxes comprises:
determining a first number of anchor boxes according to the number of anchor boxes and a preset adjustment number; and/or,
determining a first number of anchor boxes according to the number of anchor boxes and a preset adjustment coefficient; and
determining the updated number of anchor boxes based on the first number of anchor boxes.

For example, the adjustment number may be a preset constant for adjusting the number of anchor boxes, and the adjustment number can be added to the number of anchor boxes to obtain the first number of anchor boxes. The size of the adjustment number can be set according to use needs, for example, it can be set to any constant such as 1 or −2. The first number of anchor boxes can be represented by a sum of the number of anchor boxes and the adjustment number. For example, when the number of anchor boxes is represented by k and the adjustment number is −2, the first number of anchor boxes can be represented as k−2. For example, the adjustment coefficient can be a preset constant used to adjust the proportion of change in the number of anchor boxes. The adjustment coefficient can be multiplied by the number of anchor boxes to obtain the first number of anchor boxes. The value of the adjustment coefficient can be set according to use needs, for example, it can be set to any constant such as 1, 0.9 or 0.8.

For example, the adjustment number and the adjustment coefficient can be simultaneously used to determine the number of first anchor boxes. It is possible to first add the number of anchor boxes to the adjustment number to obtain a second number of anchor boxes, and then multiply the second number of anchor boxes by the adjustment coefficient to obtain the first number of anchor boxes. It is also possible to multiply the number of anchor boxes by the adjustment coefficient to obtain a third number of anchor boxes, and then add the third number of anchor boxes to the adjustment number to obtain the first number of anchor boxes.

In the present embodiment, by the setting of the adjustment number and/or the adjustment coefficient, a flexible adjustment of the number of anchor boxes can be achieved. By adjusting the number of anchor boxes by different degrees, it is possible to make the number of anchor boxes more adaptable to the current model iteration, to improve the stability of model detection, and to avoid a decrease in the stability of model detection caused by the anchor box classification threshold being set too high or too low due to a too high or too low number of anchor boxes.

For example, on the basis of any of the above embodiments, determining the updated number of anchor boxes based on the first number of anchor boxes comprises:
if the first number of anchor boxes is greater than a preset upper limit number of anchor boxes, determining the preset upper limit number of anchor boxes as the updated number of anchor boxes; and
if the first number of anchor boxes is less than or equal to the preset upper limit number of anchor boxes, determining the first number of anchor boxes as the updated number of anchor boxes.

For example, updating the number of anchor boxes can be achieved by inputting the number of anchor boxes into a formula for updating the number of anchor boxes to obtain a new number of anchor boxes by calculation, thereby achieving an accurate update of the number of anchor boxes.

For example, the formula for updating the number of anchor boxes can be expressed as:
K2=min (maxk,β(k1+α), where α is an adjustment number for the number of anchor boxes, and β is an adjustment coefficient for the number of anchor boxes. maxk is a preset upper limit number of anchor boxes, i.e., a preset maximum number of anchor boxes. k1 can be a number of anchor boxes used for the current iteration training, and k2 can be an updated number of anchor boxes, which can be used for the next iteration.

The adjustment number, the adjustment coefficient, and the upper limit number of anchor boxes can be set according to use needs. For example, the adjustment number can be set to −2, the adjustment coefficient can be set to 1, and the upper limit number of anchor boxes can be set to 7.

In the present embodiment, the first number of anchor boxes can be a number of anchor boxes adjusted by the adjustment number and/or the adjustment coefficient. The updated first number anchor boxes is constrained by the upper limit number of anchor boxes, such that when the first number of anchor boxes is greater than the upper limit number of anchor boxes, the upper limit number of anchor boxes is determined as the updated number of anchor boxes; otherwise, the first number of anchor boxes is determined as the updated number of anchor boxes. The upper limit number of anchor boxes is a preset empirical value, which is a quantitative value of the number of anchor boxes obtained through multiple tests. Since the setting of the number of anchor boxes can directly affect the anchor box classification threshold, when the first number of anchor boxes is constrained by the upper limit number of anchor boxes, it is possible to avoid the problem of the anchor box classification threshold being in an unreasonable numerical range for a long period of time due to a case of an unconstrained number of anchor boxes. The problem may further lead to the need for the target detection model to perform multiple iterations of training to adjust the anchor box classification threshold to a reasonable value. By using the method of the embodiment of the present disclosure, the efficiency of adjusting the anchor box classification threshold is improved, so that the number of model iterations can be effectively reduced, and the construction speed of the target detection model can be improved.

In some embodiments, selecting, from the plurality of anchor boxes, target anchor boxes that meet the anchor box similarity condition based on the ground truth box and the number of anchor boxes comprises:
for at least one ground truth box, calculating degrees of similarity of each ground truth box corresponding respectively to the plurality of anchor boxes;
sorting the degrees of similarity of each ground truth box corresponding to the plurality of anchor boxes in a descending order, to obtain a sorting result corresponding to each ground truth box; and
based on the number of anchor boxes k and the sorting result corresponding to each ground truth box, determining top-k anchor boxes corresponding to each ground truth box as the target anchor boxes corresponding to the ground truth box.

For example, the degree of similarity between the ground truth box and the anchor box may include an Intersection over Union (IOU) of the anchor box corresponding to the ground truth box. The intersection of the anchor box and the ground truth box can be determined first, and then the union of the anchor box and the ground truth box can be determined. The ratio of the intersection to the union can be calculated to obtain an IOU value of the anchor box as the degree of similarity. Furthermore, in addition to the ratio of the intersection to the union of the anchor box and the ground truth box as described above, the IOU may also include any one of a Generalized Intersection over Union (GIOU), Distance-Intersection over Union (DIOU), etc. The present disclosure does not make too many restrictions to the specific calculation method used for the IOU.

In the embodiments of the present disclosure, based on the anchor boxes and the ground truth boxes corresponding to the anchor boxes, a degree of similarity corresponding to each ground truth box and each of the plurality of anchor boxes can be calculated. By sorting the degrees of similarity, the acquisition of the closest and most similar target anchor boxes can be achieved for each ground truth box, and the accuracy of the anchor box classification threshold is further improved.

For example, based on any of the embodiments, determining an anchor box classification threshold based on the ground truth box and the target anchor boxes comprises:
determining an IOU of the ground truth box with each target anchor box, according to the target anchor box corresponding to the ground truth box; and
determining the anchor box classification threshold according to the IOU of the ground truth box with each target anchor box.

For example, one ground truth box may correspond to a plurality of target anchor boxes, and for each ground truth box, an IOU of the ground truth box with each corresponding target anchor box may be calculated. The IOUs of the ground truth boxes with each corresponding target anchor box are sorted, to determine the anchor box classification threshold.

For example, it is possible to sort the IOUs of the ground truth boxes with each corresponding target anchor box to obtain a sorting result of IOU corresponding to each target anchor box, and select the IOU corresponding to the median of the sorting results of IOUs of K target anchor boxes corresponding to the respective ground truth boxes as the anchor box classification threshold. The mean value of the IOUs of the ground truth box and each corresponding target anchor box can also be calculated to obtain the anchor box classification threshold.

For example, the IOUs of K target anchor boxes corresponding to the respective ground truth boxes may also be added to obtain a sum of the IOUs, and a total number of target anchor boxes corresponding to the K target anchor boxes corresponding to the respective ground truth boxes may also be determined. A quotient of the sum of the IOUs and the total number of target anchor boxes may be calculated to serve as the anchor box classification threshold. The numbers of K target anchor boxes corresponding to different ground truth boxes can be the same or different.

For example, it is assumed that there are three ground truth boxes, and the three ground truth boxes correspond to K1, K2 and K3 target anchor boxes, respectively. IOU sorting can be performed on the target anchor boxes corresponding respectively to the three ground truth boxes, to obtain sorting results of the (K1+K2+K3) target anchor boxes, and the IOU of the target anchor box corresponding to the median of the sorting results can be taken as the anchor box sorting threshold.

Likewise, as an example, there are three ground truth boxes, and the three ground truth boxes correspond to K1, K2 and K3 target anchor boxes, respectively. The respective IOUs of the K1 target anchor boxes, K2 target anchor boxes and K3 target anchor boxes can be added to obtain a sum of the IOUs, and a total number of target anchor boxes of the K target anchor boxes corresponding to the respective ground truth boxes can be calculated, which is: K1+K2+K3. A quotient of the sum of the IOUs and the total number of target anchor boxes may be calculated to serve as the anchor box classification threshold.

For example, using the median as the anchor box classification threshold can be expressed using the following formula:

$$median ( {IOU}_{top - k} )$$

where top-k can be K target anchor boxes that meet the anchor box similarity condition corresponding to the ground truth boxes, and median denotes a function that takes the median of IOU values of the K target anchor boxes.

In the embodiments of the present disclosure, after performing the selection of target anchor boxes for the ground truth boxes, the anchor box classification threshold can be determined by means of the k target anchor boxes corresponding to the ground truth boxes, so that the anchor box classification threshold makes reference to the k target anchor boxes, and the target anchor boxes are anchor boxes that meet the anchor box similarity condition as compared with the ground truth boxes, and thus better match actual detection requirements. Thus, the accuracy and precision of the anchor box classification threshold can be improved by means of the target anchor boxes.

FIG. 5 is a flowchart of a target detection model construction method provided in an embodiment of the present disclosure, which differs from the foregoing embodiment in that step 203 of performing update to the target detection model according to the anchor box classification threshold and the plurality of anchor boxes corresponding to the sample image, may comprise the following steps:
501: according to the anchor box classification threshold and the ground truth box corresponding to the sample image, classifying each of the plurality of anchor boxes to obtain a classification result corresponding to each of the plurality of anchor boxes, the classification result including a positive or negative sample.

For example, the classification result corresponding to an anchor box may include that the anchor box belongs to a positive sample of a certain ground truth box or that the anchor box is a negative sample. There can be one or more positive samples corresponding to one ground truth box. In addition, the classification result may also include other classification result that does not belong to a positive or negative sample, and an anchor box that is determined to be such other classification result may not be involved in subsequent training of the target detection model.
502: according to the target detection model, performing a target detection based on a positive-class anchor box whose classification result is a positive sample, to obtain a detection result corresponding to the positive-class anchor box.

For example, the positive-class anchor box may include an anchor box that corresponds to a certain ground truth box and belongs to a positive sample of the ground truth box.
503: performing iterative update to the target detection model according to the detection result corresponding to the positive-class anchor box and the ground truth box.

For example, step 503 may include: calculating error loss based on the detection result corresponding to the positive-class anchor box and the ground truth box. It is determined whether to terminate the iteration of the target detection model according to the error loss; if so, the current target detection model is obtained; if not, the target detection model is updated and step 205 is executed.

The target detection model may predict an offset for a positive-class anchor box and its corresponding ground truth box. That is, for a positive-class anchor box, the target detection model may predict a first offset between the positive-class anchor box and a ground truth box with which the positive-class anchor box most closely matches, the first offset being a predicted value. The actual ground truth box corresponding to the positive-class anchor box has been determined in step 501, so a second offset between the positive-class anchor box and its corresponding ground truth box can be calculated, the second offset being a calculated value. Based on the first offset and the second offset of each positive-class sample, loss calculation can be performed to obtain the error loss of the target detection model.

Regarding the steps related to iteration termination determination and error loss calculation of the target detection model, reference can be made to the description of related technologies, which would not be repeated here.

For example, the classification result of positive or negative sample of the anchor box can be determined by the following formula:

$$bbox = \{ \begin{matrix}positive sample , & IOU > thr \\ negative sample , & IOU \leq thr\end{matrix}$$

where bbox represents the classification result of the anchor box, and thr is the anchor box classification threshold.

In the embodiments of the present disclosure, in the iterative training process of the target detection model, the plurality of anchor boxes may be classified by using the anchor box classification threshold and the ground truth box, to obtain classification results of the respective anchor boxes. The classification results may include positive samples or negative samples. After the anchor boxes are classified, a target detection can be performed based on a positive-class anchor box whose classification result is a positive sample according to the target detection model, to obtain a detection result corresponding to the positive-class anchor box. That is, the target detection for positive-class anchor box can be achieved by anchor box classification and model detection, enabling the target detection model to learn the characteristics of the positive sample. As the sample classification is realized based on the anchor box classification threshold, the dynamic adjustment of the anchor box classification threshold can continuously optimize the classification results of the respective anchor boxes, and further, the continuously optimized anchor box classification results can be used to train the target detection model, thereby effectively improving the detection accuracy of the target detection model and reducing the false positive rate of the model.

For example, on the basis of any of the above embodiments, step 501 may include:
according to the ground truth box corresponding to the sample image, determining an IOU of each of the plurality of anchor boxes with respect to the ground truth box;
in response to the IOU of an anchor box being less than the anchor box classification threshold, determining the classification result of the anchor box as being a negative sample; and
for each ground truth box, in response to the IOU of the anchor box with respect to the ground truth box being greater than the anchor box classification threshold, determining the anchor box as a positive sample corresponding to the ground truth box.

For any anchor box, in response to the IOU of the anchor box being less than the anchor box classification threshold, determining the classification result of the anchor box as being a negative sample, and the anchor box is no longer involved in the positive sample selection for the ground truth box.

For the respective ground truth boxes, one ground truth box may correspond to one or more respective anchor boxes. In response to the IOU of the anchor box corresponding to the ground truth box with the ground truth box being greater than the anchor box classification threshold, determine the anchor box corresponding to the ground truth box as a positive sample of the ground truth box.

For example, the step of determining the positive samples corresponding to each ground truth box may include: first determining an IOU of the ground truth box with each of at least one respective anchor box, and then selecting, from the at least one anchor box corresponding to the ground truth box, an anchor box that have the IOU value greater than the anchor box classification threshold as a positive sample corresponding to the ground truth box. Each ground truth box may correspond to one or more positive samples. One positive sample of the ground truth box refers to an anchor box corresponding to the ground truth box and having an IOU greater than the anchor box classification threshold.

In the present embodiment, by comparing the IOUs corresponding to the anchor boxes and the ground truth boxes to the anchor box classification threshold, the anchor boxes can be classified as positive or negative samples, and classification can also be performed for the positive and negative samples of the ground truth boxes, which can realize the comprehensive classification of the anchor boxes. Through the accurate classification of the anchor boxes, it is possible to obtain more accurate positive and negative samples. Further, when the positive samples are used for training of the target detection model, the detection accuracy of the target detection model for the positive samples can be improved, and more stable model detection results can be obtained, so that the stability of model detection is improved, and the false positive rate of the model is reduced.

For example, the steps of calculating an IOU corresponding to each anchor box may include: first determining a ground truth box corresponding to the anchor box; and calculating an IOU value of each anchor box with the ground truth box corresponding to the anchor box to obtain the IOU value corresponding to each anchor box. Afterwards, the IOU value of each anchor box can be compared to the anchor box classification threshold to obtain a threshold comparison result corresponding to each anchor box. The threshold comparison result includes “greater than the anchor box classification threshold” or “less than or equal to the anchor box classification threshold”. According to the threshold comparison result of each anchor box, an anchor box of which the threshold comparison result is “greater than the anchor box classification threshold” can be determined as a positive sample, and an anchor box of which the threshold comparison result is “less than or equal to the anchor box classification threshold” can be determined as a negative sample.

For example, determining a ground truth box corresponding to each anchor box may include:
calculating IOU values of each anchor box respectively with at least one ground truth box, to obtain the ground truth box corresponding to the largest IOU of each anchor box as the ground truth box corresponding to the anchor box.

For example, the classification result of positive or negative sample of the anchor box can be determined by the following formula:

$$bbox = \{ \begin{matrix}positive sample , & IOU > thr \\ negative sample , & IOU \leq thr\end{matrix}$$

where bbox represents the classification result of the anchor box, and thr is the anchor box classification threshold.

For example, a quality evaluation threshold may be calculated using the anchor box classification threshold. The steps of calculating the quality evaluation threshold includes:
multiplying the anchor box classification threshold by a threshold adjustment coefficient to obtain a first-quality threshold, and adding the first-quality threshold to a threshold adjustment amount to obtain the quality evaluation threshold. That is, the formula for calculating the quality evaluation threshold Qthr may be:

$$Qthr = Δ t 2 + Δ t 1 * thr$$

where thr is the anchor box classification threshold, Δt1 is the threshold adjustment coefficient, and Δt2 is the threshold adjustment amount. The threshold adjustment coefficient and the threshold adjustment amount can be set according to use needs, for example, the adjustment coefficient can be set to ⅔, and the adjustment amount can be set to ⅓.

In the present embodiment, by using the anchor box classification threshold and the quality threshold calculation formula, the quality evaluation threshold can be obtained by calculation. The quality evaluation threshold is determined based on the anchor box classification threshold, and the quality evaluation threshold is used to determine a proportion of first-quality anchor boxes. When the proportion of first-quality anchor boxes is greater than a preset proportion threshold, an update of the target anchor boxes can be performed, which in turn enables an update of the anchor box classification threshold. For example, when the proportion of the first-quality anchor boxes is greater than the preset proportion threshold, it means that the anchor box classification threshold is set relatively high. At this time, the number of anchor boxes can be dynamically reduced and the target anchor boxes can be updated based on the updated number of anchor boxes. From the aforementioned embodiments, it can be seen that the anchor box classification threshold can be dynamically increased through the above method, and the increase of the anchor box classification threshold can screen positive samples with higher IOU, i.e., positive samples with higher quality, to be involved in the training of the target detection model, which in turn enables the target detection model to learn from the positive samples with higher IOU to thereby reduce the false positive rate of the model.

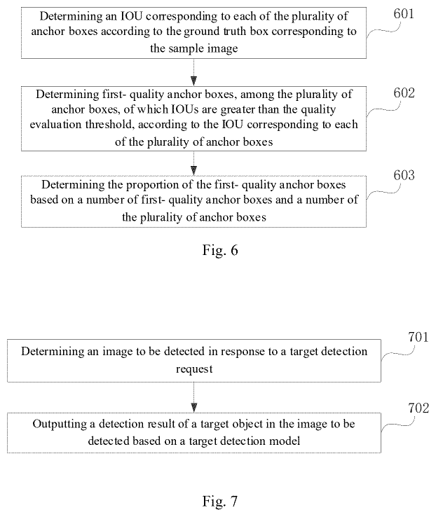

FIG. 6 shows a flowchart of a target detection model construction method provided in an embodiment of the present disclosure, which differs from the foregoing embodiment in that, in step 205, the determining a proportion of first-quality anchor boxes among the plurality of anchor boxes according to a quality evaluation threshold may include:
601: determining an IOU corresponding to each of the plurality of anchor boxes with respect to the ground truth box corresponding to the sample image.

Regarding the steps of calculating the IOU of the anchor box, reference can be made to the description of the aforementioned embodiments, which would not be repeated herein.
602: determining first-quality anchor boxes, among the plurality of anchor boxes, that have an IOU greater than the quality evaluation threshold, according to the IOU corresponding to each of the plurality of anchor boxes.

The first-quality anchor boxes are selected from the plurality of multiple anchor boxes based on the quality evaluation threshold.
603: determining the proportion of the first-quality anchor boxes based on a number of first-quality anchor boxes and a number of the plurality of anchor boxes. The quality evaluation threshold is greater than the anchor box classification threshold.

For example, the target detection model can perform multiple rounds of training iteration. At each round of training iteration, the target detection model can determine the first-quality anchor boxes from all anchor boxes of all training images in the current round of training through steps 601-603, to determine the proportion of the first-quality anchor boxes among all the anchor boxes in the current round of iteration. By dynamically determining the proportion of the first-quality anchor boxes throughout the entire training process, a dynamic adjustment of the anchor box classification threshold is realized throughout the training process.

In the embodiments of the present disclosure, the quality evaluation of each anchor box can be performed by determining the IOU of each anchor box, to obtain the first-quality anchor boxes that have an IOU greater than the quality evaluation threshold. In the training process of the target detection model, the proportion of the first-quality anchor boxes is used to determine whether to update the anchor box classification threshold to achieve the dynamic adjustment of the anchor box classification threshold, such that the target detection model can learn accurate positive samples, thereby reducing the false positive rate of the target detection model.

For example, the determining an IOU corresponding to each of the plurality of anchor boxes with respect to the ground truth box corresponding to the sample image may include:
according to at least one ground truth box corresponding to the sample image, calculating an IOU of each anchor box corresponding to each of the at least one ground truth box; and
according to the IOU of each anchor box corresponding to each of the at least one ground truth box, determining the largest IOU corresponding to each anchor box so as to determine the IOU corresponding to each of the plurality of anchor boxes.

For any anchor box, the IOU of the anchor box corresponding to each of the at least one ground truth box can be determined, and the largest IOU is determined from the IOU of the anchor box corresponding to each of the at least one ground truth box. The largest IOU is used as the IOU corresponding to the anchor box.

In the embodiments of the present application, when there is at least one ground truth box, the IOU of each anchor box corresponding to each of the at least one ground truth box can be calculated, so that the largest IOU corresponding to each anchor box is used as the IOU corresponding to each anchor box. The IOU can indicate the degree of similarity between the anchor box and each ground truth box. The larger the IOU, the more similar the anchor box is to the ground truth box. Therefore, the largest IOU is used as the IOU corresponding to the anchor box. The IOU corresponding to the anchor box is related to the ground truth box that is most similar to it, so that the IOU corresponding to the anchor box can more accurately represent its detection effect in the sample image. The IOU corresponding to the anchor box is used to evaluate the quality of the anchor box, to determine first-quality anchor boxes from all anchor boxes in the current round of training. The proportion of the first-quality anchor boxes can be used to determine whether to update the target anchor boxes. The target anchor boxes are used to determine the anchor box classification threshold. The anchor box classification threshold has a high impact on the training accuracy of the target detection model. Therefore, the accurate evaluation of the anchor box is beneficial for obtaining a more accurate anchor box classification threshold, which in turn can effectively improve the model precision of the target detection model and reduce the false positive rate of the model.

FIG. 7 shows a flowchart of a target detection method provided in an embodiment of the present disclosure. The method may comprise the following steps:
701: determining an image to be detected in response to a target detection request; and
702: outputting a detection result of a target object in the image to be detected based on a target detection model, the target detection model being constructed based on the target detection model construction method provided in any of the above embodiments.

In the embodiments of the present disclosure, when there is a target detection request, an image to be detected and a plurality of anchor boxes of the image to be detected can be determined in response to the target detection request, to output, by the target detection model, an anchor box where the target object is located in the image to be detected and an anchor box class corresponding to the detection box. The target detection model can be obtained by construction through the above embodiments, and the target anchor boxes are dynamically adjusted during the construction process, whereby the classification effect of the anchor box classification threshold can be improved by the adjustment of the target anchor boxes, so that the target detection model can perform more accurate detection on the anchor boxes to improve the detection precision of the target classification model, and reduce the false positive rate.

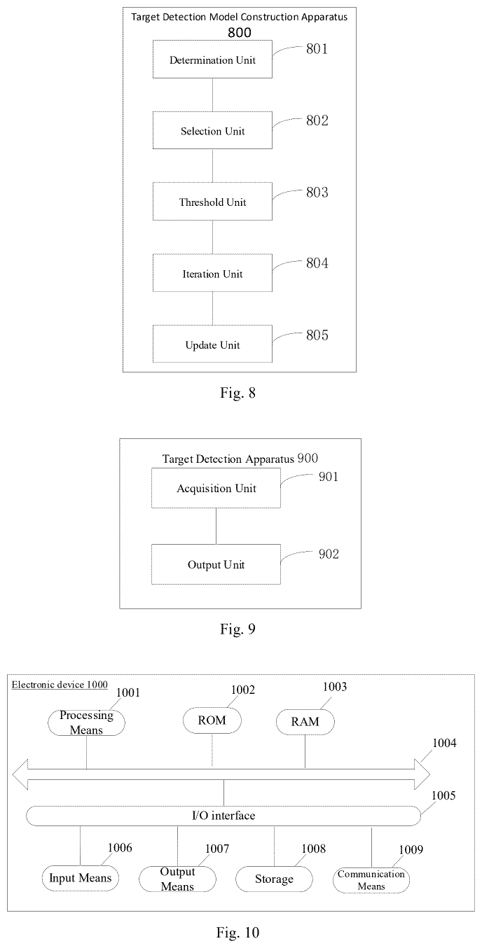

FIG. 8 is a flowchart of a target detection model construction apparatus provided in an embodiment of the present disclosure. The target detection model construction apparatus 800 may include:
a determination unit 801, configured to determine a plurality of anchor boxes of a sample image based on a target detection model;
a selection unit 802, configured to select, from the plurality of anchor boxes, target anchor boxes that meet an anchor box similarity condition based on a ground truth box of the sample image;
a threshold unit 803, configured to determine an anchor box classification threshold based on the ground truth box and the target anchor boxes;
an iteration unit 804, configured to perform iterative update to the target detection model according to the anchor box classification threshold and the plurality of anchor boxes corresponding to the sample image; and
an update unit 805, configured to: while an iteration of the target detection model is not terminated, determine a proportion of first-quality anchor boxes among the plurality of anchor boxes based on a quality evaluation threshold, and in response to the proportion of the first-quality anchor boxes being greater than a preset proportion threshold, update the target anchor boxes; the quality evaluation threshold being determined based on the anchor box classification threshold; the first-quality anchor boxes being anchor boxes, among the plurality of anchor boxes, that have an IOU with the ground truth box greater than the quality evaluation threshold.

As an embodiment, the selection unit 802 comprises:
a number determination module, configured to determine a number of anchor boxes corresponding to the target anchor boxes set for the ground truth box; and
a target selection module, configured to select, from the plurality of anchor boxes, target anchor boxes that meet the anchor box similarity condition according to the ground truth box and the number of anchor boxes; and
the update unit comprises:
a model update module, configured to update the number of anchor boxes, and select, from the plurality of anchor boxes, target anchor boxes that meet the anchor box similarity condition according to the updated number of anchor boxes and the ground truth box.

In some embodiments, the model update module comprises:
a first determination submodule, configured to determine a first number of anchor boxes according to the number of anchor boxes and a preset adjustment number; and/or,
a first determination submodule, configured to determine a first number of anchor boxes according to the number of anchor boxes and a preset adjustment coefficient; and
a number determination submodule, configured to determine the updated number of anchor boxes based on the first number of anchor boxes.

In some embodiments, the number determination submodule is configured to:
in response to the first number of anchor boxes being greater than a preset upper limit number of anchor boxes, determine the preset upper limit number of anchor boxes as the updated number of anchor boxes; and
in response to the first number of anchor boxes being less than or equal to the preset upper limit number of anchor boxes, determining the first number of anchor boxes as the updated number of anchor boxes.

In some embodiments, the model selection module comprises:
a calculation submodule, configured to calculate, for at least one ground truth box, degrees of similarity of each ground truth box corresponding respectively to the plurality of anchor boxes;
a sorting submodule, configured to sort the degrees of similarity of each ground truth box corresponding to the plurality of anchor boxes in a descending order to obtain a sorting result corresponding to each ground truth box; and
a selection submodule, configured to determine, based on the number of anchor boxes k and the sorting result corresponding to each ground truth box, top-k anchor boxes corresponding to each ground truth box as target anchor boxes corresponding to the ground truth box.

In some embodiments, the threshold unit comprises:
a first calculation module, configured to determine an IOU of the ground truth box corresponding to each target anchor box, according to the target anchor boxes corresponding to the ground truth box; and
a threshold determination module, configured to determine an anchor box classification threshold according to the IOU of the ground truth box with each target anchor box.

In some embodiments, the iteration unit comprises:
an anchor box classification module, configured to classifying each of the plurality of anchor boxes according to the anchor box classification threshold and the corresponding ground truth box corresponding to the sample image, to obtain a classification result corresponding to each of the plurality of anchor boxes, the classification result including a positive or negative sample;
a positive detection module, configured to perform a target detection based on a positive-class anchor box of which the classification result is a positive sample according to the target detection model, to obtain a detection result corresponding to the positive-class anchor box; and
a model update module, configured to perform iterative update to the target detection model according to the detection result corresponding to the positive-class anchor box and the ground truth box.

In some embodiments, the anchor box classification module comprises:
an IOU calculation submodule, configured to: according to the ground truth box corresponding to the sample image, determine an IOU of each of the plurality of anchor boxes with respect to the ground truth box;
a first classification submodule, configured to: in response to the IOU corresponding to the anchor box being less than the anchor box classification threshold, determine the classification result of the anchor box as a negative sample; and
a second classification submodule, configured to: for each ground truth box, in response to the IOU of the anchor box with respect to the ground truth box being greater than the anchor box classification threshold, determine the anchor box as a positive sample corresponding to the ground truth box.

In some embodiments, the iteration unit comprises:
a second calculation module, configured to determine an IOU corresponding to each of the plurality of anchor boxes according to the ground truth box corresponding to the sample image;
a quality evaluation module, configured to determine first-quality anchor boxes, among the plurality of anchor boxes, that have an IOU greater than the quality evaluation threshold, according to the IOU corresponding to each of the plurality of anchor boxes; and
a proportion calculation module, configured to determine a proportion of the first-quality anchor boxes according to a number of the first-quality anchor boxes and a number of the plurality of anchor boxes.

The quality evaluation threshold is greater than the anchor box classification threshold.

In some embodiments, the second calculation module is configured to:
according to at least one ground truth box corresponding to the sample image, calculate an IOU of each anchor box with respect to each of the at least one ground truth box; and according to the IOU of each anchor box with respect to each of the at least one ground truth box, determine the largest IOU corresponding to each anchor box so as to determine the IOU corresponding to each of the plurality of anchor boxes.

FIG. 9 is a flowchart of a target detection apparatus provided in an embodiment of the present disclosure. The target detection apparatus 900 may comprise:
an acquisition unit 901, configured to determine an image to be detected in response to a target detection request; and
a detection unit 902, configured to output a detection result of a target object in the image to be detected based on a target detection model. The target detection model is obtained by training based on the target detection model construction method provided in any of the above embodiments.

The apparatus provided in the present embodiment can be used to perform the technical solutions of the above method embodiments with similar implement principles and technical effects, which would not be repeated here.

In order to implement the above embodiments, an embodiment of the present disclosure also provides an electronic device, comprising: a processor and a memory. The memory stores computer-executable instructions.

The processor executes the computer-executable instructions stored in the memory, such that the processor executes the target detection model construction method and the target detection method according to any of the above embodiments.

The device provided in the present embodiment can be used to perform the technical solutions of the above method embodiments with similar implement principles and technical effects, which would not be repeated here.

Referring to FIG. 10, it shows a schematic diagram of a structure of an electronic device 1000 suitable for use in implementing the embodiments of the present disclosure. The electronic device 1000 may be a terminal device or a server. The terminal device may include, but is not limited to, a mobile terminal such as a mobile phone, a laptop computer, a digital broadcast receiver, a Personal Digital Assistant (PDA), a Portable Android Device (PAD), a Portable Media Player (PMP), a vehicle-mounted terminal (e.g., a vehicle-mounted navigation terminal), and a fixed terminal such as a digital TV and a desktop computer. The electronic device illustrated in FIG. 10 is merely an example and should not impose any limitations on the functionality and scope of use of the embodiments of the present disclosure.

As shown in FIG. 10, the electronic device 1000 may include a processing means 1001 (e.g., a central processor, a graphics processor, etc.) that may perform various appropriate actions and processes based on a program stored in a Read Only Memory (ROM) 1002 or a program loaded from a storage 1008 into a Random Access Memory (RAM) 1003. Various programs and data necessary for the operation of the electronic device 1000 are also stored in the RAM 1003. The processing means 1001, the ROM 1002, and the RAM 1003 are connected to each other via a bus 1004. An Input/output (I/O) interface 1005 is also connected to the bus 1004.

Typically, the following devices may be connected to the I/O interface 1005: an input means 1006 including, for example, a touch screen, a touch pad, a keyboard, a mouse, a camera, a microphone, an accelerometer, a gyroscope, and the like; an output means 1007 including, for example, a Liquid Crystal Display (LCD), a loudspeaker, a vibrator, and the like; the storage 1008 including, for example, a magnetic tape, a hard disk, etc.; and a communication means 1009. The communication means 1009 may allow the electronic device 1000 to communicate with other devices through wired or wireless communication to exchange data. Although FIG. 10 illustrates the electronic device 1000 with various means, it should be understood that it is not required to implement or comprise all of the illustrated means. Alternatively, it is possible to implement or comprise more or fewer means.

For example, according to the embodiments of the present disclosure, the process described above with reference to the flowchart may be implemented as a computer software program. For example, an embodiment of the present disclosure includes a computer program product comprising a computer program carried on a computer-readable medium, the computer program comprising program code for performing the method as shown in the flowchart. In such an embodiment, the computer program may be downloaded and installed from a network via the communication means 1009, or installed from the storage 1008, or installed from the ROM 1002. When the computer program is executed by the processing means 1001, the above functions as defined in the method of the embodiments of the present disclosure are performed.

It is noted that the computer-readable medium described above in the present disclosure may be a computer-readable signal medium or a computer-readable storage medium or any combination thereof. The computer-readable storage medium may, for example, be, but is not limited to, an electrical, magnetic, optical, electromagnetic, infrared, or semiconductor system, means or device, or a combination of any of the above. An example of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), a fiber optic, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as part of a carrier carrying computer-readable program code. Such a propagated data signal may take a variety of forms, including, but not limited to, an electromagnetic signal, an optical signal, or any suitable combination thereof. In addition to the computer-readable storage medium, the computer-readable signal medium may also be any computer-readable medium. The computer-readable signal medium may send, propagate, or transmit a program for use by, or in combination with, an instruction execution system, apparatus or device. The program code contained on the computer-readable medium may be transmitted using any suitable medium, including, but not limited to: wire, fiber optic cable, RF (radio frequency), etc., or any suitable combination thereof.

An embodiment of the present disclosure also provides a computer-readable storage medium having stored thereon computer-executable instructions that, when executed by a processor, implement the target detection model construction method and the target detection method according to any of the above embodiments.

An embodiment of the present disclosure also provides a computer program product, comprising a computer program that, when executed by a processor, implements the target detection model construction method and the target detection method according to any of the above embodiments.

The computer-readable medium mentioned above may be included in the electronic device mentioned above, or it may exist separately without being assembled into the electronic device.

The above-mentioned computer-readable medium carries one or more programs, which, when executed by the electronic device, cause the electronic device to perform the method illustrated in the above embodiments.

Computer program code for performing the operations of the present disclosure may be written in one or more programming languages or combinations thereof, including object-oriented programming languages, such as Java, Smalltalk, C++, and conventional procedural programming languages, such as the “C” language or similar programming languages. The program code may be executed entirely on a user's computer, partially on a user's computer, as a stand-alone software package, partially on a user's computer and partially on a remote computer, or entirely on a remote computer or server. In situations involving a remote computer, the remote computer may be connected to the user's computer via any kind of network, including a Local Area Network (LAN) or a Wide Area Network (WAN), or it may be connected to an external computer (e.g., via an Internet connection using an Internet service provider).

The flowcharts and block diagrams in the accompanying drawings illustrate the architecture, functionality, and operation of systems, methods, and computer program product that may be implemented according to various embodiments of the present disclosure. In this regard, each box in the flowcharts or block diagrams may represent a module, program segment, or portion of code that contains one or more executable instructions for implementing a specified logical function. It should also be noted that, in some alternative implementations, the functions indicated in the boxes may also occur in a different order than that indicated in the accompanying drawings. For example, two consecutively represented boxes may actually be executed substantially in parallel, and they may sometimes be executed in a reverse order, depending on the functions involved. It is also noted that each of the boxes in the block diagrams and/or flowcharts, and combinations of the boxes in the block diagrams and/or flowcharts, may be implemented with a specialized hardware-based system that performs specified functions or operations, or may be implemented with a combination of specialized hardware and computer instructions.

The units described in the embodiments of the present disclosure may be implemented by way of software or by way of hardware. The name of a unit does not constitute, in certain circumstance, a limitation on the unit itself, e.g., a first acquisition unit may also be described as “a unit for acquiring at least two Internet Protocol addresses”.

The functions described above herein may be performed, at least in part, by one or more hardware logic components. As a non-limiting example, exemplary types of hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. An examples of the machine-readable storage medium may include an electrical connection based on one or more wires, a portable computer disk, a hard disk, a random access memory (RAM), a read-only memory (ROM), an erasable programmable read-only memory (EPROM or flash memory), a fiber optic, a portable compact disk read-only memory (CD-ROM), an optical storage device, a magnetic storage device, or any suitable combination of the foregoing.

In a first aspect, according to one or more embodiments of the present disclosure, there is provided a target detection model construction method, comprising:
determining a plurality of anchor boxes of a sample image based on a target detection model;
selecting, from the plurality of anchor boxes, target anchor boxes that meet an anchor box similarity condition based on a ground truth box of the sample image;
determining an anchor box classification threshold based on the ground truth box and the target anchor boxes;
performing iterative update to the target detection model according to the anchor box classification threshold and the plurality of anchor boxes corresponding to the sample image; and
in response to an iteration of the target detection model not being terminated, determining a proportion of first-quality anchor boxes among the plurality of anchor boxes according to a quality evaluation threshold, and in response to the proportion of the first-quality anchor boxes being greater than a preset proportion threshold, updating the target anchor boxes, the quality evaluation threshold being determined based on the anchor box classification threshold, the first-quality anchor boxes being anchor boxes, among the plurality of anchor boxes, that have an Intersection over Union (IOU) with the ground truth box greater than the quality evaluation threshold.

According to one or more embodiments of the present disclosure, selecting, from the plurality of anchor boxes, target anchor boxes that meet an anchor box similarity condition based on a ground truth box comprises:
determining a number of anchor boxes corresponding to the target anchor boxes set for the ground truth box;
selecting, from the plurality of anchor boxes, target anchor boxes that meet the anchor box similarity condition according to the ground truth box and the number of anchor boxes;
updating the target anchor boxes comprises:
updating the number of anchor boxes, and selecting, from the plurality of anchor boxes, target anchor boxes that meet the anchor box similarity condition according to the updated number of anchor boxes and the ground truth box.

According to one or more embodiments of the present disclosure, updating the number of anchor boxes comprises:
determining a first number of anchor boxes according to the number of anchor boxes and a preset adjustment number; and/or,
determining a first number of anchor boxes according to the number of anchor boxes and a preset adjustment coefficient; and
determining the updated number of anchor boxes based on the first number of anchor boxes.

According to one or more embodiments of the present disclosure, determining the updated number of anchor boxes based on the first number of anchor boxes comprises:
in response to the first number of anchor boxes being greater than a preset upper limit number of anchor boxes, determining the preset upper limit number of anchor boxes as the updated number of anchor boxes; and
in response to the first number of anchor boxes being less than or equal to the preset upper limit number of anchor boxes, determining the first number of anchor boxes as the updated number of anchor boxes.

According to one or more embodiments of the present disclosure, selecting, from the plurality of anchor boxes, target anchor boxes that meet an anchor box similarity condition, according to the ground truth box and the number of anchor boxes comprises:
for at least one ground truth box, calculating degrees of similarity of each ground truth box corresponding respectively to the plurality of anchor boxes;
sorting the degrees of similarity of each ground truth box corresponding to the plurality of anchor boxes in a descending order, to obtain a sorting result corresponding to each ground truth box; and
based on the number k of anchor boxes and the sorting result corresponding to each ground truth box, determining top-k anchor boxes corresponding to each ground truth box as target anchor boxes corresponding to the ground truth box.

According to one or more embodiments of the present disclosure, determining an anchor box classification threshold based on the ground truth box and the target anchor boxes comprises:
determining an IOU of the ground truth box with each target anchor box according to the target anchor boxes corresponding to the ground truth box; and
determining the anchor box classification threshold according to the IOU of the ground truth box with each target anchor box.

According to one or more embodiments of the present disclosure, performing iterative update to the target detection model according to the anchor box classification threshold and the plurality of anchor boxes corresponding to the sample image comprises:
according to the anchor box classification threshold and the ground truth box corresponding to the sample image, classifying each of the plurality of anchor boxes, to obtain a classification result corresponding to each of the plurality of anchor boxes, the classification result including a positive or negative sample; and
according to the target detection model, performing a target detection based on a positive-class anchor box of which the classification result is a positive sample, to obtain a detection result corresponding to the positive-class anchor box;
performing iterative update to the target detection model according to the detection result corresponding to the positive-class anchor box and the ground truth box.

According to one or more embodiments of the present disclosure, the steps of classifying the anchor boxes comprise:
according to the ground truth box corresponding to the sample image, determining an IOU of each of the plurality of anchor boxes with respect to the ground truth box;
in response to the IOU corresponding to the anchor box being less than the anchor box classification threshold, determining the classification result of the anchor box as a negative sample; and
for each ground truth box, in response to the IOU of the anchor box with respect to the ground truth box being greater than the anchor box classification threshold, determining the anchor box as a positive sample corresponding to the ground truth box.

According to one or more embodiments of the present disclosure, determining a proportion of first-quality anchor boxes among the plurality of anchor boxes according to a quality evaluation threshold comprises:
determining an IOU corresponding to each of the plurality of anchor boxes according to the ground truth box corresponding to the sample image;
determining first-quality anchor boxes, among the plurality of anchor boxes, that have an IOU greater than the quality evaluation threshold, according to the IOU corresponding to each of the plurality of anchor boxes; and
determining the proportion of the first-quality anchor boxes based on a number of the first-quality anchor boxes and a number of the plurality of anchor boxes,
the quality evaluation threshold being greater than the anchor box classification threshold.

According to one or more embodiments of the present disclosure, determining an IOU corresponding to each of the plurality of anchor boxes according to the ground truth box corresponding to the sample image comprises:
according to at least one ground truth box corresponding to the sample image, calculating an IOU of each anchor box with respect to each of the at least one ground truth box; and
according to the IOU of each anchor box with respect to each of the at least one ground truth box, determining the largest IOU corresponding to each anchor box, so as to determine the IOU corresponding to each of the plurality of anchor boxes.

In a second aspect, according to one or more embodiments of the present disclosure, there is provided a target detection method, comprising:
an acquisition unit, configured to determine an image to be detected in response to a target detection request; and
a detection unit, configured to output a detection result of a target object in the image to be detected based on a target detection model. The target detection model is obtained by training based on the target detection model construction method provided in any of the above embodiments.

In a third aspect, according to one or more embodiments of the present disclosure, there is provided a target detection model construction apparatus, comprising:
a determination unit, configured to determine a plurality of anchor boxes of a sample image based on a target detection model;
a selection unit, configured to select, from the plurality of anchor boxes, target anchor boxes that meet an anchor box similarity condition, based on a ground truth box of the sample image;
a threshold unit, configured to determine an anchor box classification threshold based on the ground truth box and the target anchor boxes;
an iteration unit, configured to perform iterative update to the target detection model according to the anchor box classification threshold and the plurality of anchor boxes corresponding to the sample image; and
an update unit, configured to: in response to an iteration of the target detection model being not terminated, determine a proportion of first-quality anchor boxes among the plurality of anchor boxes according to a quality evaluation threshold, and in response to the proportion of the first-quality anchor boxes being greater than a preset proportion threshold, update the target anchor boxes, the quality evaluation threshold being determined based on the anchor box classification threshold, the first-quality anchor boxes being anchor boxes, among the plurality of anchor boxes, that have an IOU with the ground truth box greater than the quality evaluation threshold.

In a fourth aspect, according to one or more embodiments of the present disclosure, there is provided a target detection apparatus, comprising:
an acquisition unit, configured to determine an image to be detected in response to a target detection request; and
a detection unit, configured to output a detection result of a target object in the image to be detected based on a target detection model. The target detection model is obtained by training based on the target detection model construction method provided in any of the above embodiments.

In a fifth aspect, according to one or more embodiments of the present disclosure, there is provided an electronic device, comprising: at least one processor and a memory,
the memory storing computer-executable instructions,
the at least one processor executing the computer-executable instructions stored in the memory such that the at least one processor executes the target detection model construction method and the target detection method according to the first aspect as well as various possible target detection model construction methods and target detection methods that may be involved in the first aspect.

In a sixth aspect, according to one or more embodiments of the present disclosure, there is provided a computer-readable storage medium having stored therein computer-executable instructions that, when executed by a processor, implement the target detection model construction method and the target detection method provided in any of the above embodiments.

In a seventh aspect, according to one or more embodiments of the present disclosure, there is provided a computer program product comprising a computer program that, when executed by a processor, implements the target detection model construction method and the target detection method provided in any of the above embodiments.

The contents described above are only preferred embodiments of the present disclosure and illustrations of the technical principles utilized. It should be understood by those skilled in the art that the scope of the present disclosure is not limited to technical solutions formed by specific combinations of the above technical features, but also should cover other technical solutions formed by any combination of the above technical features or their equivalent features without departing from the above disclosed concepts. For example, a technical solution formed by replacing the above features with (but not limited to) technical features with similar functions disclosed in the present disclosure.

Furthermore, although the operations are depicted using a particular order, this should not be construed as requiring that the operations be performed in the particular order shown or in a sequential order. Under certain circumstances, multitasking and parallel processing may be advantageous. Likewise, although several implementation details are included in the above discussion, these should not be construed as limiting the scope of the present disclosure. Certain features described in the context of individual embodiments may also be combined and implemented in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. On the contrary, the specific features and actions described above are merely exemplary forms of implementing the claims.

1. A target detection model construction method, comprising:
determining a plurality of anchor boxes of a sample image based on a target detection model;
selecting, from the plurality of anchor boxes, target anchor boxes that meet an anchor box similarity condition based on at least one ground truth box of the sample image;
determining an anchor box classification threshold based on the at least one ground truth box and the target anchor boxes;
performing iterative update to the target detection model according to the anchor box classification threshold and the plurality of anchor boxes of the sample image; and
determining, in response to an iteration of the target detection model not being terminated, a proportion of first-quality anchor boxes among the plurality of anchor boxes according to a quality evaluation threshold, and updating the target anchor boxes in response to the proportion of the first-quality anchor boxes being greater than a preset proportion threshold, wherein the quality evaluation threshold is determined based on the anchor box classification threshold, and the first-quality anchor boxes are anchor boxes, among the plurality of anchor boxes, that have an Intersection over Union (IOU) with the at least one ground truth box greater than the quality evaluation threshold.

2. The target detection model construction method according to claim 1, wherein, the selecting, from the plurality of anchor boxes, target anchor boxes that meet an anchor box similarity condition based on the at least one ground truth box comprises:
determining a number of anchor boxes corresponding to the target anchor boxes set for the at least one ground truth box; and
selecting, from the plurality of anchor boxes, target anchor boxes that meet the anchor box similarity condition according to the at least one ground truth box and the number of anchor boxes; and
the updating the target anchor boxes comprises:
updating the number of anchor boxes, and selecting, from the plurality of anchor boxes, target anchor boxes that meet the anchor box similarity condition according to the updated number of anchor boxes and the at least one ground truth box.

3. The target detection model construction method according to claim 2,
wherein, the updating the number of anchor boxes comprises:
determining a first number of anchor boxes according to the number of anchor boxes and at least one of a preset adjustment number or a preset adjustment coefficient; and
determining the updated number of anchor boxes based on the first number of anchor boxes.

4. The target detection model construction method according to claim 3, wherein, the determining the updated number of anchor boxes based on the first number of anchor boxes comprises:
in response to the first number of anchor boxes being greater than a preset upper limit number of anchor boxes, determining the preset upper limit number of anchor boxes as the updated number of anchor boxes; and
in response to the first number of anchor boxes being less than or equal to the preset upper limit number of anchor boxes, determining the first number of anchor boxes as the updated number of anchor boxes.

5. The target detection model construction method according to claim 2, wherein, the selecting, from the plurality of anchor boxes, target anchor boxes that meet the anchor box similarity condition according to the at least one ground truth box and the number of anchor boxes comprises:
for the at least one ground truth box, calculating degrees of similarity of each ground truth box of the at least one ground truth box corresponding to the plurality of anchor boxes;
sorting the degrees of similarity of each ground truth box corresponding to the plurality of anchor boxes in a descending order, to obtain a sorting result corresponding to each ground truth box; and
based on the number k of anchor boxes and the sorting result corresponding to each ground truth box, determining top-k anchor boxes corresponding to each ground truth box as target anchor boxes corresponding to each ground truth box.

6. The target detection model construction method according to claim 1, wherein, the determining an anchor box classification threshold based on the at least one ground truth box and the target anchor boxes comprises:
according to the target anchor boxes corresponding to the at least one ground truth box, determining an IOU of each of the at least one ground truth box with each target anchor box; and
according to the IOU of each of the at least one ground truth box with each target anchor box, determining the anchor box classification threshold.

7. The target detection model construction method according to claim 1, wherein, the performing iterative update to the target detection model according to the anchor box classification threshold and the plurality of anchor boxes of the sample image comprises:
according to the anchor box classification threshold and the ground truth box corresponding to the sample image, classifying each of the plurality of anchor boxes, to obtain a classification result corresponding to each of the plurality of anchor boxes, the classification result including a positive or negative sample;
according to the target detection model, performing a target detection based on a positive-class anchor box of which the classification result is a positive sample, to obtain a detection result corresponding to the positive-class anchor box; and
performing iterative update to the target detection model according to the detection result corresponding to the positive-class anchor box and the ground truth box.

8. The target detection model construction method according to claim 7, wherein, the classifying each of the plurality of anchor boxes comprise:
according to the ground truth box corresponding to the sample image, determining an IOU of each of the plurality of anchor boxes with respect to the ground truth box;
in response to the IOU corresponding to the anchor box being less than the anchor box classification threshold, determining the classification result of the anchor box as a negative sample; and
in response to the IOU corresponding to the anchor box being greater than the anchor box classification threshold, determining the classification result of the anchor box as a positive sample corresponding to the ground truth box.

9. The target detection model construction method according claim 1, wherein, the determining a proportion of first-quality anchor boxes among the plurality of anchor boxes according to a quality evaluation threshold comprises:
determining an IOU corresponding to each of the plurality of anchor boxes according to the at least one ground truth box corresponding to the sample image;
determining first-quality anchor boxes, among the plurality of anchor boxes, that have the IOUs greater than the quality evaluation threshold, according to the IOU corresponding to each of the plurality of anchor boxes; and
determining the proportion of the first-quality anchor boxes, according to a number of the first-quality anchor boxes and a number of the plurality of anchor boxes, the quality evaluation threshold being greater than the anchor box classification threshold.

10. The target detection model construction method according to claim 9, wherein, the determining the IOU corresponding to each of the plurality of anchor boxes according to the at least one ground truth box corresponding to the sample image comprises:
according to the at least one ground truth box corresponding to the sample image, calculating an IOU of each anchor box corresponding to each of the at least one ground truth box; and
according to the IOUs of each anchor box corresponding to the at least one ground truth box, determining the largest IOU corresponding to each anchor box, so as to determine the IOU corresponding to each of the plurality of anchor boxes.

11. A target detection method, comprising:
determining an image to be detected in response to a target detection request; and
outputting a detection result of a target object in the image to be detected based on a target detection model, the target detection model being obtained based on the target detection model construction method provided in claim 1.

12-13. (canceled)

14. An electronic device, comprising: a processor, and a memory, the memory storing computer-executable instructions, the processor executing the computer-executable instructions stored in the memory such that the processor is configured to perform a target detection model construction method comprising:
determining a plurality of anchor boxes of a sample image based on a target detection model;
selecting, from the plurality of anchor boxes, target anchor boxes that meet an anchor box similarity condition based on at least one ground truth box of the sample image;
determining an anchor box classification threshold based on the at least one ground truth box and the target anchor boxes;
performing iterative update to the target detection model according to the anchor box classification threshold and the plurality of anchor boxes of the sample image; and
determining, in response to an iteration of the target detection model not being terminated, a proportion of first-quality anchor boxes among the plurality of anchor boxes according to a quality evaluation threshold, and updating the target anchor boxes in response to the proportion of the first-quality anchor boxes being greater than a preset proportion threshold, wherein the quality evaluation threshold is determined based on the anchor box classification threshold, and the first-quality anchor boxes are anchor boxes, among the plurality of anchor boxes, that have an Intersection over Union (IOU) with the at least one ground truth box greater than the quality evaluation threshold.

15. A non-transitory computer-readable storage medium having stored thereon computer-executable instructions that, when executed by a processor, implement a target detection model construction method comprising:
determining a plurality of anchor boxes of a sample image based on a target detection model;
selecting, from the plurality of anchor boxes, target anchor boxes that meet an anchor box similarity condition based on at least one ground truth box of the sample image;
determining an anchor box classification threshold based on the at least one ground truth box and the target anchor boxes:
performing iterative update to the target detection model according to the anchor box classification threshold and the plurality of anchor boxes of the sample image; and
determining, in response to an iteration of the target detection model not being terminated, a proportion of first-quality anchor boxes among the plurality of anchor boxes according to a quality evaluation threshold, and updating the target anchor boxes in response to the proportion of the first-quality anchor boxes being greater than a preset proportion threshold, wherein the quality evaluation threshold is determined based on the anchor box classification threshold, and the first-quality anchor boxes are anchor boxes, among the plurality of anchor boxes, that have an Intersection over Union (IOU) with the at least one ground truth box greater than the quality evaluation threshold.

16-17. (canceled)

18. The electronic device according to claim 14, wherein, the selecting, from the plurality of anchor boxes, target anchor boxes that meet an anchor box similarity condition based on the at least one ground truth box comprises:
determining a number of anchor boxes corresponding to the target anchor boxes set for the at least one ground truth box; and
selecting, from the plurality of anchor boxes, target anchor boxes that meet the anchor box similarity condition according to the at least one ground truth box and the number of anchor boxes; and
the updating the target anchor boxes comprises:
updating the number of anchor boxes, and selecting, from the plurality of anchor boxes, target anchor boxes that meet the anchor box similarity condition according to the updated number of anchor boxes and the at least one ground truth box.

19. The electronic device according to claim 18, wherein, the selecting, from the plurality of anchor boxes, target anchor boxes that meet the anchor box similarity condition according to the at least one ground truth box and the number of anchor boxes comprises:
for the at least one ground truth box, calculating degrees of similarity of each ground truth box of the at least one ground truth box corresponding to the plurality of anchor boxes;
sorting the degrees of similarity of each ground truth box corresponding to the plurality of anchor boxes in a descending order, to obtain a sorting result corresponding to each ground truth box; and
based on the number k of anchor boxes and the sorting result corresponding to each ground truth box, determining top-k anchor boxes corresponding to each ground truth box as target anchor boxes corresponding to each ground truth box.

20. The electronic device according to claim 14, wherein, the determining an anchor box classification threshold based on the at least one ground truth box and the target anchor boxes comprises:
according to the target anchor boxes corresponding to the at least one ground truth box, determining an IOU of each of the at least one ground truth box with each target anchor box; and
according to the IOU of each of the at least one ground truth box with each target anchor box, determining the anchor box classification threshold.

21. The electronic device according to claim 14, wherein, the performing iterative update to the target detection model according to the anchor box classification threshold and the plurality of anchor boxes of the sample image comprises:
according to the anchor box classification threshold and the ground truth box corresponding to the sample image, classifying each of the plurality of anchor boxes, to obtain a classification result corresponding to each of the plurality of anchor boxes, the classification result including a positive or negative sample;
according to the target detection model, performing a target detection based on a positive-class anchor box of which the classification result is a positive sample, to obtain a detection result corresponding to the positive-class anchor box; and
performing iterative update to the target detection model according to the detection result corresponding to the positive-class anchor box and the ground truth box.

22. The non-transitory computer-readable storage medium according to claim 15, wherein, the selecting, from the plurality of anchor boxes, target anchor boxes that meet an anchor box similarity condition based on the at least one ground truth box comprises:
determining a number of anchor boxes corresponding to the target anchor boxes set for the at least one ground truth box; and
selecting, from the plurality of anchor boxes, target anchor boxes that meet the anchor box similarity condition according to the at least one ground truth box and the number of anchor boxes; and
the updating the target anchor boxes comprises:
updating the number of anchor boxes, and selecting, from the plurality of anchor boxes, target anchor boxes that meet the anchor box similarity condition according to the updated number of anchor boxes and the at least one ground truth box.

23. The non-transitory computer-readable storage medium according to claim 15, wherein, the determining an anchor box classification threshold based on the at least one ground truth box and the target anchor boxes comprises:
according to the target anchor boxes corresponding to the at least one ground truth box, determining an IOU of each of the at least one ground truth box with each target anchor box; and
according to the IOU of each of the at least one ground truth box with each target anchor box, determining the anchor box classification threshold.

24. The non-transitory computer-readable storage medium according to claim 15, wherein, the performing iterative update to the target detection model according to the anchor box classification threshold and the plurality of anchor boxes of the sample image comprises:
according to the anchor box classification threshold and the ground truth box corresponding to the sample image, classifying each of the plurality of anchor boxes, to obtain a classification result corresponding to each of the plurality of anchor boxes, the classification result including a positive or negative sample;
according to the target detection model, performing a target detection based on a positive-class anchor box of which the classification result is a positive sample, to obtain a detection result corresponding to the positive-class anchor box; and
performing iterative update to the target detection model according to the detection result corresponding to the positive-class anchor box and the ground truth box.
